(19) United States
(12) Patent Application Publication
(10) Pub. No.: US 2004/0007301 A1
(43) Pub. Date: Jan. 15, 2004

(54) Multi-layer tire for a baby stroller

(76) Inventor: Yu-Li Chang, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/191,067

(22) Filed: Jul. 10, 2002

(51) Int. Cl. B60B 9/00

(52) U.S. Cl. 152/246; 152/5

(57) ABSTRACT

A multi-layer tire for a baby stroller comprises an EVA (Ethylene-Vinyl Acetate Copolymer) foam tire inner tube and a rubber layer incorporated with a wheel hub. The wheel hub comprises a recess along the edge for the EVA foam tire inner tube to grab and secure thereat, whereas the EVA foam tire inner tube is formed with a pair of grooves at respective sides and wrapped by the rubber layer which comprises a pair of ribs at respective sides engaging with the grooves of the EVA foam tire inner tube to hold the rubber layer and the EVA foam tire inner tube securely.

### BACKGROUND OF THE INVENTION

1. Field of the Invention

This invention relates to a multi-layer tire for a baby stroller, and more particularly, to a tire uses EVA (Ethylene-Vinyl Acetate Copolymer) material to form the tire.

2. Description of the Prior Art

A conventional tire used for a baby stroller, as shown in FIG. 3, mostly uses the EVA foam to wrap an edge 31 of a wheel hub 3, the EVA material is able to absorb vibration, however, it is not wearable, thus the tire has to be replaced frequently. Later on manufacture has replaced the EVA material with rubber, which is wearable, but the ability of absorbing vibration is less than the EVA material and the cost is higher, too. SUMMARY of the Invention

It is the primary object of the present invention to provide a multi-layer tire for a baby stroller, which provides better vibration absorption and more comfortable to a baby.

It is another object of the present invention to provide a multi-layer tire for a baby stroller, which can secure the tire and the wheel hub together.

It is a further object of the present invention to provide a multi-layer tire for a baby stroller, which is durable.

### BRIEF DESCRIPTION OF THE DRAWINGS

FIG. 1 is a side cross-sectional view of a first embodiment of the present invention;

FIG. 2 is a side cross-sectional view of a second embodiment of the present invention; and

FIG. 3 is a side cross-sectional view of a prior art.

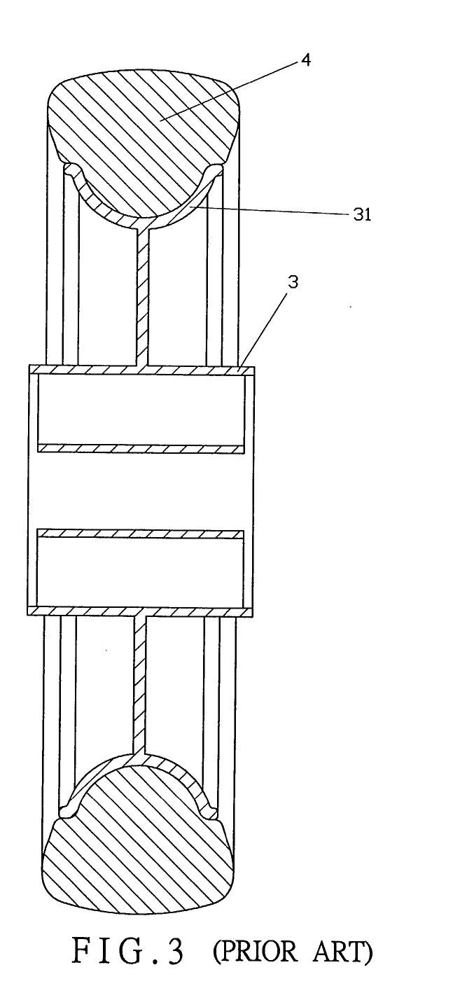

### DETAILED DESCRIPTION OF THE PREFERRED EMBODIMENTS

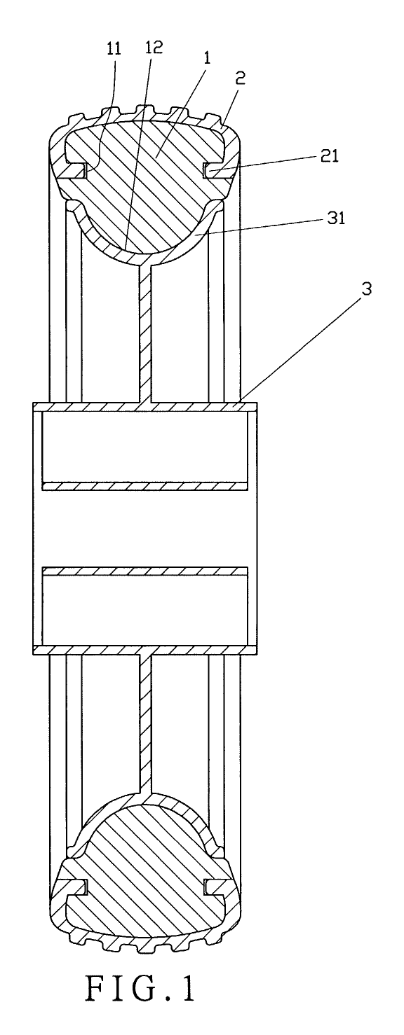

As shown in FIG. 1, the tire of the present invention includes an EVA (Ethylene-Vinyl Acetate Copolymer) foam tire inner tube 1 and a rubber layer 2 incorporated with a wheel hub 3. The wheel hub 3 is formed with a recess 31 along its edge, and an inner surface 12 of the EVA form tire inner tube 1 secures with the recess 31, and the characterized is in that the EVA foam tire inner tube 1 comprises a pair of grooves 11 at respective sides, and the rubber layer 2 comprises a pair of ribs 21 extending from both sides corresponding to the grooves 11 of the inner tube 1 so that the ribs 21 are inserted into the grooves 11 to secure the rubber layer 2 and the EVA foam tire inner tube 1 together, to form a tire with soft elasticity inside and durable hard material outside of the present invention.

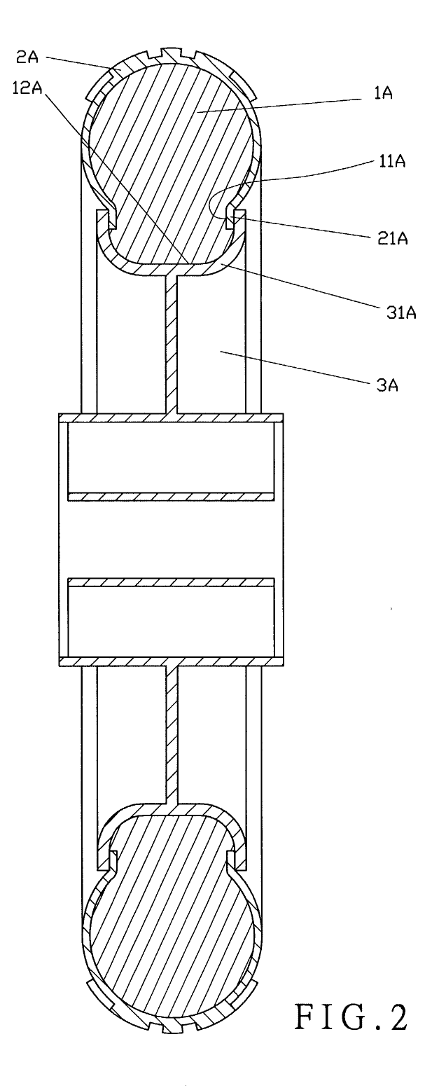

As shown in FIG. 2, a second embodiment of the present invention comprises an EVA (Ethylene-Vinyl Acetate Copolymer) foam tire inner tube 1A, a rubber layer 2A, and a wheel hub 3A. The wheel hub 3A has a recess 31A along its edge, and the EVA foam tire inner tube 1A uses its inner surface 12A grabbing the recess 31A to secure itself with the wheel hub 3A. The EVA foam tire inner tube 1A comprises a pair of grooves 11A at respective sides, and the rubber layer 2A comprises a pair of ribs 21A corresponding to the grooves 11A of the EVA foam tire inner tube 1A in such a manner that the ribs 21A are inserted into the grooves 11A to secure the rubber layer 2A and the EVA foam tire inner tube 1A together, whereas, the ribs 21A will be held by both sides of the recess 31A of the wheel hub 3A securely.

I claim:

1. A multi-layer tire for a baby stroller comprising an EVA (Ethylene-Vinyl Acetate Copolymer) foam tire inner tube and a rubber layer, both being secured on a wheel hub, whereas said wheel hub comprising a recess along the edge for securing an inner surface of said EVA foam tire inner tube, and being characterized in that,
said EVA foam tire inner tube comprising a pair of grooves at respective sides, and said rubber layer comprising a pair of ribs at respective sides corresponding to said grooves of said EVA foam tire inner tube, so that when said ribs of said rubber layer being inserted into corresponding grooves of said EVA foam tire inner tube to secure said rubber layer and said EVA foam tire inner tube together.

2. The multi-layer tire for a baby stroller, as recited in claim 1, wherein said EVA foam tire inner tube comprises a pair of grooves at respective sides and said rubber layer comprises a pair of ribs corresponding to said grooves of said EVA foam tire inner tube, whereas said ribs of said rubber layer are inserted into said grooves of said EVA foam tire inner tube and directly wrapped by both sides of said recess of said wheel hub.
